(19) United States
(12) Patent Application Publication
(10) Pub. No.: US 2004/0050219 A1
(43) Pub. Date: Mar. 18, 2004

(54) Driving tool

(76) Inventors: Ernest A. Carroll, Herndon, VA (US); Steven D. Gottlieb, Herndon, VA (US)

Correspondence Address: Ernest A. Carroll, 12913 Alton Square, No. 114, Herndon, VA, 20170, US

(21) Appl. No.: 10/244,006

(22) Filed: Sep. 16, 2002

(51) Int. Cl. B25B 23/10

(52) U.S. Cl. 81/452

(57) ABSTRACT

A driving tool capable of grasping and driving screw type devices having polygonal drive sockets. The tool comprises a body or shaft having an axis of rotation, an enlarged head textured to enhance grip by hand, and a driving bit for engaging the socket of a screw type device. The bit comprises two opposed jaws separated by a gap. The jaws project from the shaft and are longitudinally aligned with the axis of rotation. The jaws are tapered so that they can enter the socket of a screw type device. The jaws collectively have a polygonal external periphery, for example, hexagonal, that cooperates with the polygonal drive socket. The driving tool is fabricated from a material exhibiting spring characteristics such that the jaws resiliently resist being compressed upon insertion into the drive socket.

### BACKGROUND OF THE INVENTION

1. Field of the Invention

The present invention relates to tools, and more particularly to a tool for grasping and driving a screw type device having a socket formed in its head for receiving a driving tool.

2. Description of the Prior Art

Fasteners and anchors bearing external screw threads are usually installed by rotatably driving them into engagement with a base or supporting stratum. Such fasteners, and anchors, which will be referred to hereinafter collectively as screws regardless of their intended purposes, are usually provided with a head having structure for engaging a driving tool, and an elongated shaft which shaft is typically threaded. The shaft advances into the supporting stratum when it is rotated. The structure of the head which engages a driving tool may comprise a polygonal external surface at the lateral sides of the head or alternatively, a polygonal socket structure formed in the exposed end surface of the head. The present invention is concerned with the latter type, wherein the head has a polygonal recess or socket configured to receive a driving bit or blade of a driving tool.

Driving tools typically have a bit or blade which is inserted into the socket and engages the socket by cooperation therewith. Interference between the socket and the bit assures that the screw device will be driven when the tool is rotated. The tool of the present invention has not only a bit enabling driving of screw devices, but also grasping of the screw device. This ability is imparted by cooperating prongs or jaws which are spaced apart from one another and compress resiliently as they penetrate the socket of the screw. The jaws engage the walls of the socket by friction, assisted by spring action of resistance to compression of the jaws.

Being able to grasp the screw is very advantageous in miniaturized applications, such as the field of dental implants. In dentistry, implants and their various associated components are so small as to be very difficult to maneuver into place by hand. U.S. Pat. No. 5,105,690, issued to Lazarra et al. on Apr. 21, 1992, illustrates a driver tool intended for small dental screws. Manufacturing the driver tool of Lazarra et al. requires forming the bit in two sections of similar cross section, but different configurations as viewed in side elevation. The smaller section, which is not tapered, is a driving section, while the larger tapered section is that intended to engage the walls of a socket by friction.

### SUMMARY OF THE INVENTION

The present invention provides a screw grasping and driving tool for screws such as fasteners, anchors and other devices, which tool engages a polygonal socket formed in the head of the screw. The novel tool has two opposed jaws separated by a small gap. The jaws are configured to be received in the socket of the screw, having at least a portion of their externals surfaces inclined to facilitate insertion. Insertion into the socket resiliently urges the jaws towards one another as progressively wider portions of the jaws enter the socket. The screw is then engaged and held by friction and by spring action of the compressed jaws. The tool is used to transport the screw to its intended location, and to rotatably drive the screw home. Thus, only one tool and one manipulation of the tool enable the screw to be transported, set in place, and tightened in place.

The novel arrangement of the jaws improves over the device of Lazarra et al. in that less effort is required to machine or otherwise fabricate the driving tool. Notably, in the present invention, the driving and grasping sections are integral with one another. This characteristic enables only one section to be formed during fabrication rather than two sections of different dimensions. Also, engagement of the screw socket is accomplished not only by elastic compression of the constituent material of the driving tool, as seen in Lazarra et al., but also by resilient spring action of the jaws, which jaws are absent in Lazarra et al.

Accordingly, it is one object of the invention to provide a screw grasping and driving tool which improves over the prior art.

It is another object of the invention to enhance grasp of a socket by utilizing both elastic compression of the constituent material of the driving tool and also spring action.

An additional object of the invention is to reduce difficulty of fabricating a screw grasping and driving tool.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational view of one embodiment of the invention.

FIG. 2 is an enlarged perspective detail view of the bottom of FIG. 1.

FIG. 3 is similar to FIG. 2, but shows an alternative configuration of the jaws of the driving bit.

FIG. 4 is an enlarged environmental side elevational view of the embodiment of FIG. 1 engaging a screw for driving the latter.

### DETAILED DESCRIPTION OF THE PREFERRED EMBODIMENTS

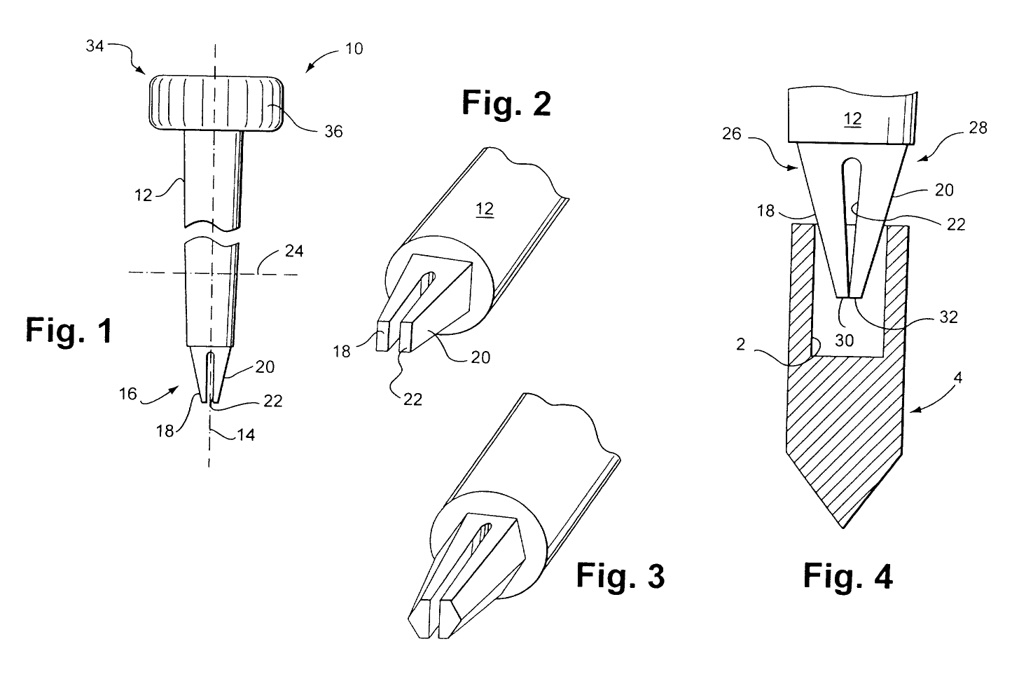

FIG. 1 of the drawings shows a driving tool 10 for grasping and rotatably driving a screw (see FIG. 4) of the type having a socket for engaging a driving tool. Driving tool 10 comprises a body 12 having an axis 14 of rotation and a driving bit 16 comprising two opposed jaws 18, 20 fixed to body 12. Body 12 preferably takes the form of an elongate shaft, as depicted in FIG. 1, although much shorter embodiments are contemplated. A gap 22 separates jaws 18, 20 from one another.

The gap may have several sections rather than having configuration of a single straight line segment. For example, in an alternative embodiment of the invention (not shown) having three jaws, a three section gap separates each jaw from every other jaw. This latter situation applies in particular to polygonal configurations having an odd number of sides, such as triangles and pentagons. When using a polygonal configuration having an even number of sides, such as square and hexagonal, it is preferred to use a gap having configuration of a straight line segment. However, it would be possible to modify this scheme, for example, to remove constituent material to decrease resistance to compression when the jaws are being inserted into a socket.

The gap may intersect the outer periphery of the jaws at a straight face, as illustrated herein, at an intersection of straight faces (this construction is not shown), or in any combination of these.

As clearly seen in FIG. 2, jaws 18, 20 collectively have a drivingly effective generally polygonal outer peripheral cross sectional configuration, where the cross sectional configuration is taken on a plane (such as for example plane 24 shown in FIG. 1) oriented at an oblique angle to axis 14 of rotation. Referring also to FIG. 4, wherein jaws 18, 20 of driving tool 10 have entered and engaged a socket 2 of a screw 4, it will be appreciated that the drivingly effective outer peripheral cross sectional configuration cooperates closely with socket 2. It will be appreciated that the same cross sectional configuration occurs at different points along the length of jaws 18, 20, although to progressively increasing dimensions from the end of jaws 18, 20 to body 12.

The outer peripheral cross sectional configuration of jaws 18, 20 is that of a regular polygon having sides of equal length. In the embodiment of FIG. 2, this configuration is square. In an alternative embodiment shown in FIG. 3, this configuration is hexagonal. The embodiment of FIG. 3 is similar to that of FIG. 2 except for the cross sectional configuration of the driving bit.

For the purposes of this invention, polygonal signifies that the outer boundary includes only straight line segments wherein an oblique enclosed angle is formed at the intersection of any two line segments. Generally polygonal signifies that discontinuities in the outer polygonal configuration, where such discontinuities are caused by the gap, are not considered to be present if they do not interfere with cooperation between jaws of tool and socket of the driven device. The generally polygonal configuration may be present when the tool is in the uncompressed state, that is, not inserted into socket, or alternatively, may be present only after jaws are compressed and urged towards one another during insertion into a socket.

Jaws 18, 20 engage the walls of socket 2 by friction. Cooperation with socket 2 and frictional grip of socket 2 are enhanced by resilient spring action of jaws 18, 20. Jaws 18, 20, and preferably all of driving tool 10, are fabricated from a material displaying spring characteristics causing jaws 18, 20 to yieldingly and resiliently resist being urged together. Titanium, stainless steel, synthetic elastomers, and other materials would be suitable for imparting sufficient spring characteristics.

Each jaw 18 or 20 has a respective proximal end 26 or 28 proximate body 12, and a respective distal end 30 or 32 located away from body 12. Each jaw 18 or 20 is tapered such that it is relatively wide at its proximal end 26 or 28, and relatively narrow at its distal end 30 or 32. Taper of jaws 18, 20 need not be either linear or continuous along the entire length of one or both jaws 18, 20, although such taper, which is illustrated herein, is preferred. As jaws 18, 20 are progressively inserted into socket 2, they are compressed together so that they come to touch one another at their distal ends 30, 32. It is not necessary to compress jaws 18, 20 to the point that distal ends 30, 32 touch one another for engagement of screw 4 to succeed.

Referring again to FIG. 1, body 12 of driving tool 10 is seen to have a grasping handle 34 of diameter greater than that of body 12. Handle 34 of body 12 bears an outer surface which is textured to improve grip by hand. Texturing may take the form of ridges or reeding 36. Alternatively, texturing can be provided by roughening of the surface (not shown) or in any other suitable way. In an alternative embodiment of the invention (not shown), the outer surface may be of body 12 rather than being that of enlarged head 34.

In the embodiment of FIG. 1, which is the preferred embodiment, body 12 comprises an elongate shaft having length coincident with axis 14 of rotation. In the preferred embodiment, jaws 18, 20 project from body 12 parallel to and coaxially with axis 14 of rotation. However, this orientation is not necessary. Rather, some offset is possible, so that in an alternative embodiment (not shown), the jaws may depart from axial alignment with the shaft or body of the tool.

It is to be understood that the present invention is not limited to the embodiments described above, but encompasses any and all embodiments within the scope of the following claims.

We claim:

1. A driving tool for grasping and rotatably driving a screw having a socket for engaging a driving tool, comprising a body having an axis of rotation and a driving bit comprising at least two opposed jaws fixed to said body and a gap separating each one of said jaws from every other said jaw, wherein
said jaws collectively have a drivingly effective generally polygonal outer peripheral cross sectional configuration, where said cross sectional configuration is taken on a plane oriented at an oblique angle to said axis of rotation, and said cross sectional configuration enables interfering driving engagement of the socket of the screw;
each jaw has a proximal end proximate said body, a distal end located away from said body, and is tapered such that said jaw is relatively wide at said proximal end and relatively narrow at said distal end; and
said jaws are fabricated integrally with said body from a material displaying spring characteristics causing said jaws to yieldingly and resiliently resist being urged together.

2. The driving tool according to claim 1, wherein said body has a grasping handle of diameter greater than that of said body.

3. The driving tool according to claim 1, wherein said body bears an outer surface which is textured to improve grip by hand.

4. The driving tool according to claim 1, wherein said body comprises an elongate shaft having length coincident with said axis of rotation, and said jaws project parallel to and coaxially with said axis of rotation.

5. The driving tool according to claim 1, wherein said polygonal outer peripheral cross sectional configuration of said jaws is that of a regular polygon having sides of equal length.

6. The driving tool according to claim 1, wherein said polygonal outer peripheral cross sectional configuration of said jaws is hexagonal.

7. The driving tool according to claim 1, wherein said polygonal outer peripheral cross sectional configuration of said jaws is square.

8. The driving tool according to claim 1, wherein said polygonal outer peripheral cross sectional configuration of said jaws is an irregular polygon.

9. The driving tool according to claim 2, wherein said handle bears an outer surface which is textured to improve grip by hand.
